(19) United States
(12) Patent Application Publication
(10) Pub. No.: US 2009/0063275 A1
(43) Pub. Date: Mar. 5, 2009

(54) METHOD AND SYSTEM TO FACILITATE SETUP OF A PROXY WEB STORE BY AN ITEMIZED SELECTION APPROACH

(76) Inventor: Asi Barak, Tel Aviv (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 12/186,553

(22) Filed: Aug. 6, 2008

Related U.S. Application Data
(60) Provisional application No. 60/954,323, filed on Aug. 7, 2007.
(60) Provisional application No. 61/050,230, filed on May 4, 2008.

(51) Int. Cl. G06Q 30/00; G06F 3/048

(52) U.S. Cl. 705/14; 705/30; 715/760

(57) ABSTRACT

A method and system for setting up and operating a facilitator Website, the facilitator Website allowing each of a plurality of stores to create a corresponding proxy Web store presence. The method includes launching the facilitator Website by supporting it in a computer server so that it can be accessed by consumers for the purpose of placing orders, setting up a database for a template of products and services to be offered by the each of the plurality of stores and logging onto the facilitator Website by each of the plurality of stores. The method also includes identifying and selecting items from the template of products and services to be offered, placing an order by a consumer, managing by the facilitator Website all of the orders that will be placed to the facilitator Website and communicating by the facilitator Website with the plurality of stores for handling the orders.

### FIELD OF THE INVENTION

The present invention relates generally to Web stores, and more particularly, the invention relates to a method and a system to allow businesses to create a Web presence by identifying and selecting items they carry, which are already listed on a pre-existing database.

### BACKGROUND OF THE INVENTION

Many people can set up a Web site for a store. But stores do not necessarily want an outsider setting up a site for them. They also may not want to hire a Web site technician to set up a site for them.

The idea of setting up a Website for stores is known. US Pat. Applic. No. 20050097005, Internet enhanced local shopping system and method, by Kendall Fargo, was published May 5, 2005. Fargo teaches Internet enhanced local shopping system in which businesses having physical stores where products and services can be purchased submit their inventories and business terms, including their geographic locations, into a searchable database available to shoppers wanting to buy products and services locally so that shoppers can find stores in their area where the products and services they desire are available and can be purchased under specified terms.

FIG. 1 is a prior art illustration of the Kendall Fargo Web store Web site system 100 currently assigned to Intuit. System 100 provides for a plurality of member stores 101 to connect via the Internet 105 and a member store interface 110 with a searchable database (search engine) 103 which can be accessed via the Internet 105 by a shopper 104 using a computer 109. The term “computer,” as used in connection with a device 109 for connecting to the Internet and browsing the web, includes any of the several known web browser devices (including mobile phones and GPS devices in cars). Each store 101 has its current inventory of products and/or services 102 (inventory data 102) in a member store inventory database 108 which is part of the member store's computerized accounting/inventory control system 110.

In addition to the inventory data 102, each member store 101 also has business data 106, such as store location, hours of business, payment options, return policies, gift wrap availability and the like. The inventory data 102 in member store inventory database 108 is made available to the searchable database 103 via the Internet 105 and member store interface 110. Typically, the interface 110 will be a web-based application, including a web page 107 which is accessed by a member store 101 via the Internet 105 in the usual manner.

A shopper 104 looking for a product or service that he or she can obtain locally, using a computer 109, connects via the Internet 105 to the searchable database 103 via a local shopper interface 112 and a local shopping link 1 13. The interface 112 is a web-based application including a web page 111 which is accessed by a shopper 104 via the Internet 105 in the usual manner. Even if the payment module 116 is not utilized by a shopper, the activity at shopper interface 112 may be of interest to a member store 101. Thus, a link 115 is provided between shopper interface 112 and member store interface 110. To provide distance and directions functions, the invention includes a location-matching module 122, and a mapping application module 114, such as MapQuest.

Each member store 101 has a computerized inventory system 117 (typically, part of accounting/inventory management software application) which includes the inventory database 108. Client software 118 automatically sends the inventory data 102 to the database 103 of system 100. In addition to manufacturer's descriptions, which can be entered into database 119 by manufacturers 123 via the Internet 105 and interface 110, database 119 can include descriptions entered by member stores 101 via the Internet and interface 110 to enhance the marketing of their products or services. If shopper 104 wants to have both a web search and a local search, both web shopping module 120 and searchable database 103 are accessed simultaneously via combined search module 121. In addition to manufacturer's descriptions, which can be entered into database 119 by manufacturers 123 via the Internet 105 and interface 110, database 119 can include descriptions entered by member stores 101 via the Internet and interface 110 to enhance the marketing of their products or services.

The Fargo application requires the member store to have an inventory database and (automatically) uploads inventory data from the member store inventory databases to the searchable database over the browser-implemented store connection. This approach is suitable to large computerized organizations.

Thus, it would be desirable to provide a method and a system to allow small as well as large businesses to create a Web presence by identifying and selecting products and services that they carry, which are already listed as a free service on a pre-existing database.

### SUMMARY OF THE INVENTION

Accordingly, it is a principal object of the present invention to provide a method and a system for a Web store Setup process to allow both large and small local businesses to create a Web presence by identifying and selecting products that they carry, which are already listed as a free service on a pre-existing database.

It is a further principal object of the present invention to provide a system with advertising based revenue.

It is one other principal object of the present invention to provide a method and a system wherein alternative and additional features relating to Web-based services will not be free.

It is another principal object of the present invention to provide a system wherein the advertising is targeted according to the ongoing refinement of a buying profile.

A method is disclosed for setting up and operating a facilitator Website, the facilitator Website allowing each of a plurality of businesses to create a corresponding proxy Web store presence. The method includes launching the facilitator Website by supporting it in a computer server so that it can be accessed by consumers for the purpose of placing orders, setting up a database for a template of products and services to be offered by the each of the plurality of businesses and logging onto the facilitator Website by each of the plurality of businesses. The method also includes identifying and selecting items from the template of products and services to be offered, placing an order by a consumer, managing by the facilitator Website all of the orders that will be placed to the facilitator Website and communicating by the facilitator Website with the plurality of businesses for handling the orders.

The system includes a large list of products and services and their properties, which may include details of product distributors according to geographic areas.

Shop owners, or a representative, may enter the facilitator Website in order to find a product and distributors that may supply them with new or old products. The shop owner may add a new product not listed in the product template. This search can be done by geographic location or by product name/type etc.

Distributors can register themselves as distributors of some products and/or, of course they can update the product list.

The present invention involves the use of a Website, which is used as a facilitator for setting up commercial proxy Web stores through which consumers can conduct business and make purchases. The proxy Web stores represent the existing commercial establishments, where these commercial establishments are either physical stores with addresses or they are virtual trading posts.

The use of the facilitator Website begins with the access by a commercial establishment that wishes to set up a Web presence, but may or may not have a Web presence. Then the user initiates a process, which moves through a template of entries which include clicking initiation of a new Web store and clicking items from an existing catalog that the store wants to sell. The catalog is generally a master catalog on the database of the facilitator Website.

The facilitator Website then launches this virtual Web store by supporting it in a computer server so that it can be accessed by consumers. The facilitator Website supports the virtual Web store that was just created. The virtual Web store can be accessed through search engines, including yellow pages. Alternatively, the virtual Web store can be accessed by direct contact. If a shopper already knows the address of that virtual Web store, he can enter it in his computer, and via the Internet can be directly linked to it. The facilitator Website can also be considered a general shopping center type of hub which has associated with it many stores. Thus, if one would access the facilitator Website and then find what stores it has associated with it, one can determine which stores to access in any geographical area.

The individual commercial establishment does not have to have an inventory database, but will simply identify which products it has from the master catalog listings, making the whole process much simpler, especially for a small store. The stores simply identify what they have available in products and or services from the list. They can optionally add necessarily details, such as prices and in this way establish their presence in that market.

Another part of this system enables consumers to identify stores which they wish to have associated with this system, stores which are not yet listed on the facilitator Website. The consumer may approach the store and suggest to them that they be listed on this facilitator Website, and if they agree, contact can be made by the facilitator Website or alternatively by the store to establish itself as a virtual Web store on the facilitator Website.

Another way for a user to establish a virtual Web presence by setting up a Web store, is to go through a call center designated for this purpose, in which the user gives the information by telephone to set up this Web store, and the call center will work with the facilitator Website and create the Web presence. This adds another optional approach for small businesses to create a Web presence.

The facilitator Website expands the business reach of the virtual Web store, because all of the orders that will be placed on the Web store can be managed by the facilitator Website. If the facilitator Website needs to be in touch with individual stores for placing orders, they can do this in several ways, either through the Internet, if the store is equipped for this kind of order receiving approach, or the facilitator Website can send the order to the store through fax, SMS, phone or any other suitable means, to enable the store to process the purchase request.

The business model also includes the provision of advertising space on the facilitator Website which generates revenue for the facilitator Website.

The advertising provided by the facilitator Website can be focused to the target market because the consumer who is using this Website for purchases has already developed a buying profile which is stored on the system, so as he accesses the system for another purchase, the facilitator Website will know what kind of advertising to present him with, because of his buying history. This targeted advertising approach, as described below, enhances the overall usefulness of the system. Based on advertising income, the facilitator Website, having a master catalog, offers free services including:
providing advertisements on the Web pages of virtual Web stores that act as proxies for real stores;
enabling the ordering of goods and services designated from the master catalog, said ordering by the real stores through the facilitator Website acting as a proxy, where the orders need not be e-orders, but may be, for example, simple postal mail, phone, SMS or fax orders sent to the Web store; and
maintaining the Web store regarding the addition, editing and removal of products and or services from the designated catalog listings.

Optionally the advertising may be removed and the following additional services may be performed for a charge:
placing orders by e-order, fax, SMS, “snail-mail,” standard phone, or mobile phone, etc; and
conducting customer relationship management (CRM) activities, including:
   call center support;
   general business management;
   advertising campaigns;
   promotions; and
   coupons, etc.

There will be a listing of services from which the shop representative will choose. Each item will have an associated charge.

Customer relationship management (CRM) provides for finding, marketing to, selling to, and servicing customers. CRM is a broadly used term that covers concepts used by businesses to manage relationships with customers. Technologies include the capture, storage and analysis of customer, vendor, business partner and internal process information. Functions include Sales, Marketing, Customer Service, Training and Performance Management.

The facilitator Website can be accessed by any mobile device, including cell phones and/or smart phones.

By using the mobile devices and GPS technology, the facilitator Website can locate the nearby physical Web stores corresponding to the proxy Web stores on the facilitator Website available for the user. The facilitator Website identifies the user's location, for example, by GPS technology, and then finds the physical Web store or Web stores nearest to the user.

The Fargo application, described above, requires that the member store has an inventory database and (automatically) uploads inventory data from the member store inventory databases to the searchable database over the browser-implemented store connection. By contrast, this is unnecessary with the present invention, since the member store representative manually selects items from a pre-existing comprehensive master catalog list displayed by the facilitator Website. Hereinafter, the term “computer user” and “user” both refer to the person who operates the Web browser, or other GUI interface, and navigates through the system of the present invention by operating a computer.

Hereinafter, the term “computer” refers to a combination of a particular computer hardware system and a particular software operating system. Examples of such hardware systems include those with any type of suitable data processor. Hereinafter, the term “computer” includes, but is not limited to, personal computers (PC) having an operating system such as DOS, Windows™, ^{OS/2}™ or Linux; Macintosh™ computers; computers having JAVA™-OS as the operating system; and graphical workstations such as the computers of Sun Microsystems™ and Siliconis Graphics™, and other computers having some version of the UNIX operating system such as AIX™ or SOLARIIS™ of Sun Microsystems™; a PalmPilot™, a PilotPC™ or any other handheld device, or any other known and available operating system. Hereinafter, the term Windows™ includes but is not limited to Windows95™, Windows 3.x™ in which “x” is an integer such as “1,” Windows NT™, Windows98™, Windows CET, Windows XP™, or any upgraded version of these operating systems by Microsoft Corp. (USA).

For the present invention, a software application could be written in substantially any suitable programming language, which could easily be selected by one of ordinary skill in the art. The programming language chosen should be compatible with the computer by which the software application is executed, and in particularly with the operating system of that computer. Examples of suitable programming languages include, but are not limited to, C, C++ and Java. Furthermore, the functions of the present invention, when described as a series of steps for a method, could be implemented as a series of software instructions for operation by a data processor, such that the present invention could be implemented as software, firmware or hardware, or a combination thereof.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

FIG. 1 is a prior art illustration of a Web store Web site;

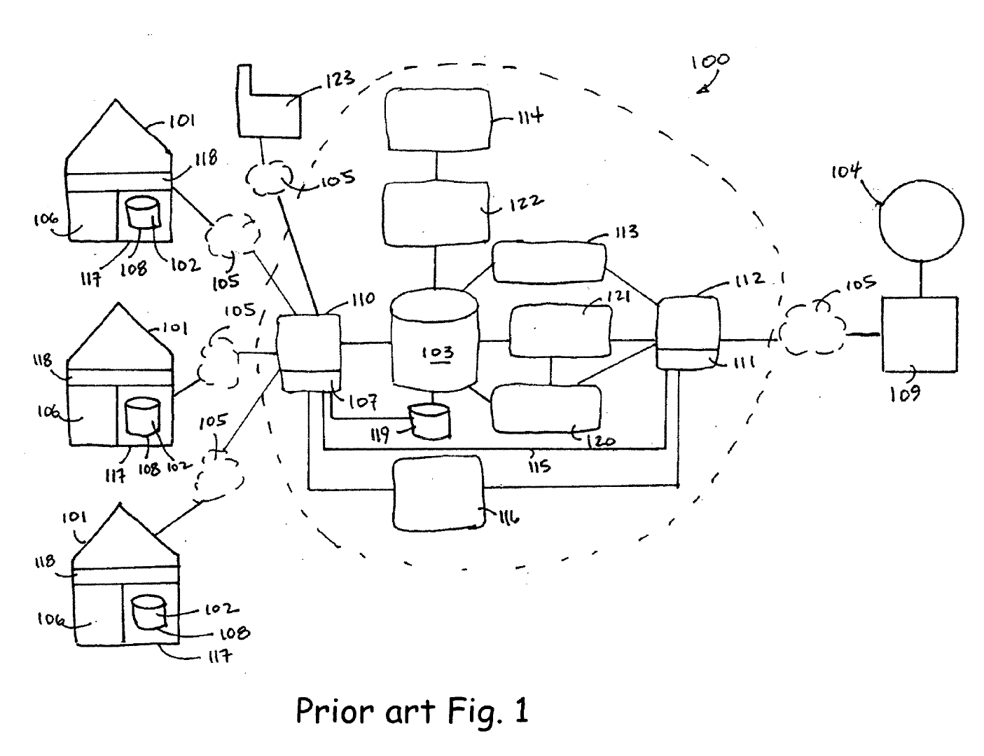

FIG. 2 is a schematic representation of the system architecture of the facilitator Website, constructed according to the principles of the present invention;

FIG. 3a is a general flow chart of the operation of the facilitator Website, performed according to the principles of the present invention;

FIG. 3b is a detailed flow chart of an example of the revenue-generating options available for the operation of the facilitator Website, performed according to the principles of the present invention;

FIG. 4 is a detailed flow chart of the distributor's access to the facilitator Website, performed according to the principles of the present invention; and

FIG. 5 is a detailed flow chart of the manufacturer's access to the facilitator Website, performed according to the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

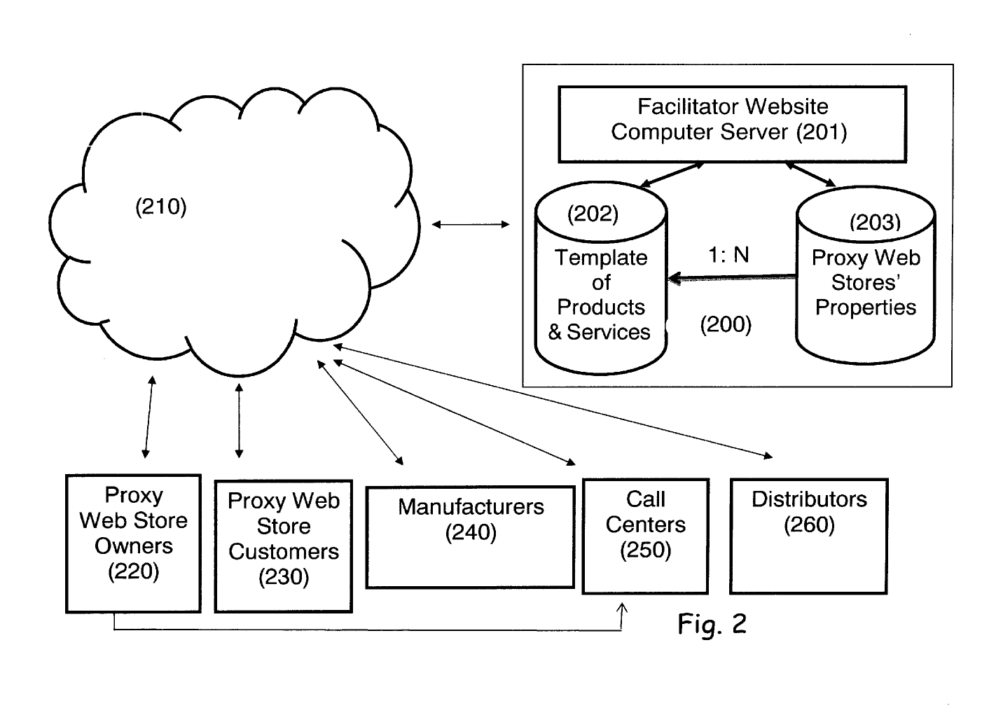

FIG. 2 is a schematic representation of the system architecture of the facilitator Website, constructed according to the principles of the present invention.

The facilitator Website 200 includes a computer server 201 and 2 main subsystems:
1) A Template of Products & Services 202, which is a list of products and services displayed on the facilitator Website, including the properties of each item: name, description, picture, etc; and
2) Proxy Web store properties 203—a list of stores, each store providing one or more items from Template of Products & Services 202 in addition to general information such as name, address, etc.
The following participants enter and communicate with facilitator Website 200 via the Internet 210:
1) Proxy Web stores owners 220 register a new proxy Web store or maintain an existing proxy Web store or update and renew a selected list of products and services in Template of Products & Services 202;
2) Proxy Web store customers 230 identify and designate products/services and submit their order. Store customers 230 may also choose to submit new products to the product template to be additionally displayed to the store customers 230;
3) Manufacturers 240 list and update their products/services—manually or automatically;
4) Call Centers 250 facilitate maintenance for proxy Web stores owners 220; and
5) Distributors 260 list and update their products—manually or automatically.
   Proxy Web Store Customers 230 who buy a product via Web 210 may receive delivery at no cost.
   By contrast, buying a product at an e-commerce shop, delivery is normally charged and more time-consuming.

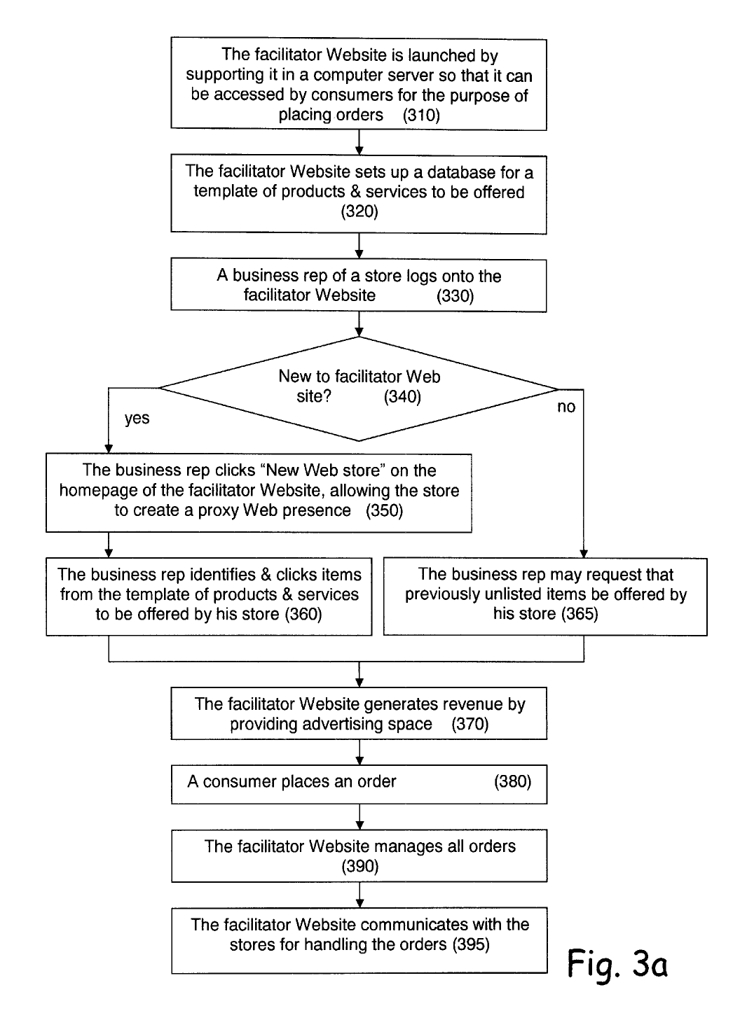

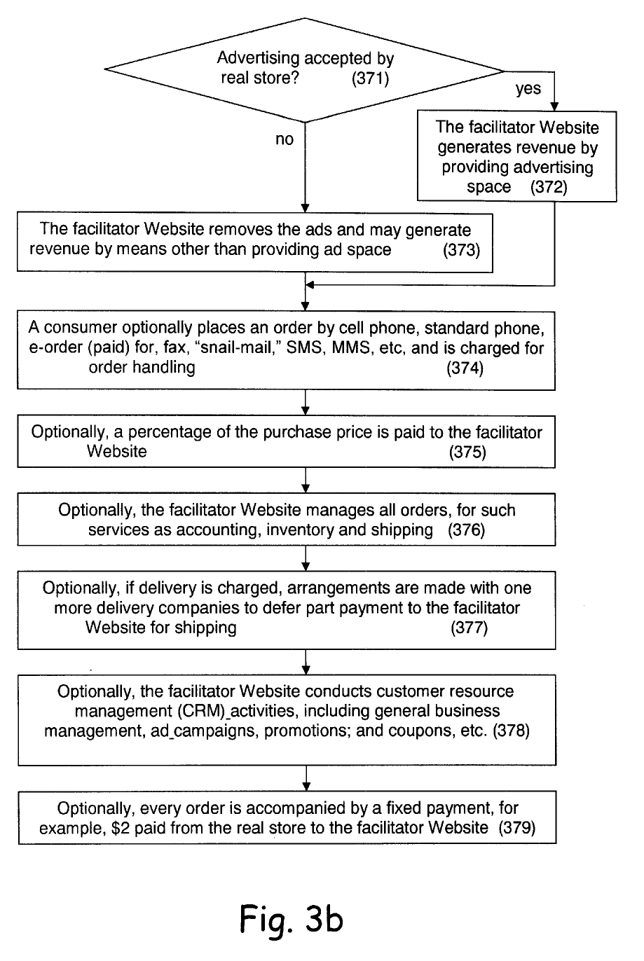

FIG. 3a is a general flow chart of the operation of the facilitator Website, performed according to the principles of the present invention. First the facilitator Website is launched by supporting it in a computer server so that it can be accessed by consumers for the purpose of placing orders in reference block 310. Then the facilitator Website sets up a database for a template of products and services to be offered by the proxy Web store in reference block 320.

A business representative of a store then logs onto the facilitator Website in reference block 330, and if the store he represents is new to the Website in reference block 340, he clicks “New Web Store” on the homepage of the facilitator Website and registers in reference block 350. The business rep then identifies and clicks items from the template of products and services, as shown above with reference to Template of Products & Services 201 of FIG. 2, to be carried by his store in reference block 360, thereby immediately allowing the store to create its own proxy Web store presence, as retrievable by a search on Google™, for example. If the store is already registered, the business rep can click additional listed items or he may request that previously listed unlisted items be listed and offered by his store in reference block 365. He can also update the price.

The facilitator Website provides targeted advertising space, thereby generating revenue for the facilitator Website in reference block 370. A consumer can access the facilitator Website to place purchase orders in reference block 380. The facilitator Website manages all of these orders in reference block 390 and the facilitator Website communicates with the stores for handling the orders in reference block 395.

The advertising can be targeted, because the consumers using the facilitator Website to place the orders develop a buying profile which is stored on the database of the Website, so as each consumer accesses the facilitator Website for another purchase, the facilitator Website will know what kind of advertising to present him with, because of his buying profile and history.

The huge product/services catalog that has been created on the facilitator Website is available for external use by other interested Websites. For example, an external Web site, such as Home Center, may want to access this catalog as an information resource for detailed product/service information.

For this purpose the facilitator Website may publish a protocol, such as that used by Web-services, in order to automatically connect the Website to other Websites.

FIG. 3b is a detailed flow chart of an example of the revenue-generating options available for the operation of the facilitator Website, performed according to the principles of the present invention.

If the real store chooses to receive advertising 371, the facilitator Website provides advertising space 372. If not, the facilitator Website removes the ads and may generate revenue by means other than providing advertising space 373. A consumer can optionally place an order by cell phone, standard phone, e-order (paid) for, fax, “snail-mail,” SMS, MMS, etc, and is charged for order handling 374. Optionally, a percentage of the purchase price is paid to the facilitator Website 375.

Optionally, the facilitator Website will manage all orders for such services as accounting, inventory and shipping 376. Optionally, if delivery is charged, arrangements are made with one more delivery companies to defer part payment to the facilitator Website for shipping 377. Optionally, the facilitator Website conducts customer resource management (CRM) activities, including general business management, advertising campaigns, promotions; and coupons, etc. 378. Optionally, every order is accompanied by a fixed payment, for example, $2 paid from the real store to the facilitator Website 379.

Accordingly, the advertising may be removed and additional services may be performed for a charge as follows:
placing orders by e-order, fax, SMS, “snail-mail,” standard phone, or mobile phone, etc; and
conducting customer relationship management (CRM) activities, including:
   call center support;
   general business management;
   advertising campaigns;
   promotions; and
   coupons, etc.

There will be a catalog of services from which the shop representative will choose. Each item will have an associated charge.

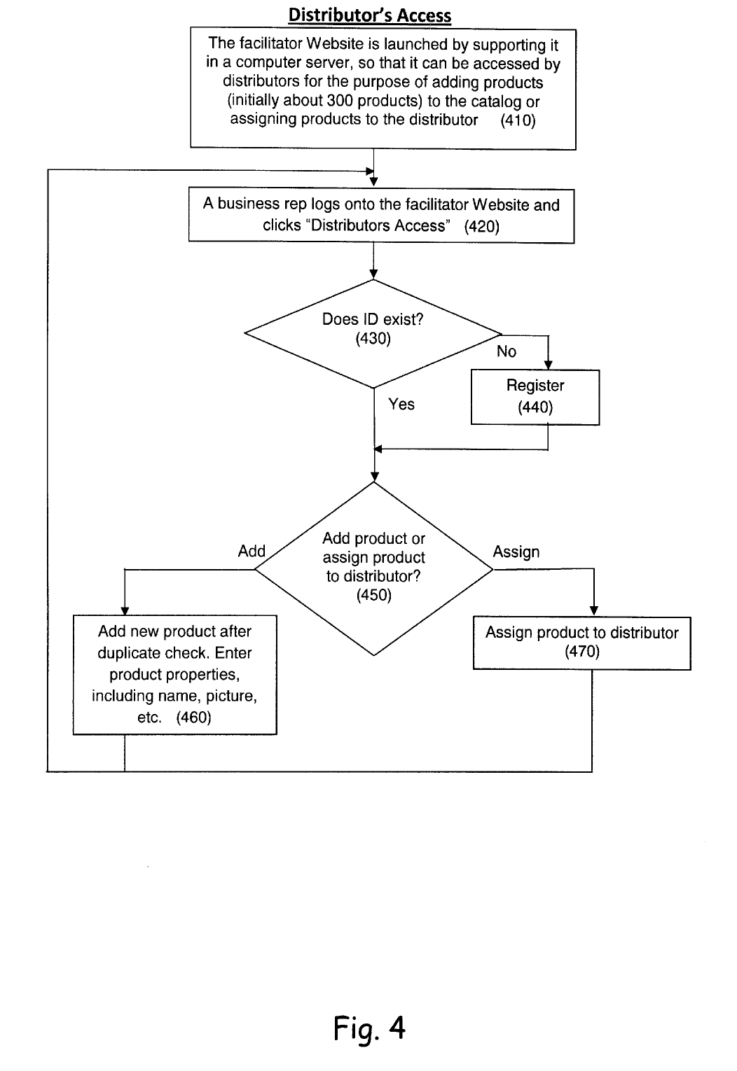

FIG. 4 is a detailed flow chart of a product distribution chain segment illustrating a distributor's access to the facilitator Website. The facilitator Website displays a separate list from which the stores, in turn, make purchases, performed according to the principles of the present invention. The facilitator Website is launched by supporting it in a computer server, so that it can be accessed by distributors for the purpose of adding products, to the catalog or assigning products to the distributor in reference block 410. A distributor logs onto the facilitator Website and clicks “Distributor's Access” in reference block 420. If the distributor has not already registered in reference block 430, the rep does so in reference block 440. After registering, or if the distributor is already registered, the Distributor's rep is asked whether he wants to add one or more products or to assign one or more products to the distributor in reference block 450. New product(s) may be added after a check for duplication, including entering product properties, including name, picture, etc. in reference block 460. Alternatively, products may be assigned to a distributor in reference block 470.

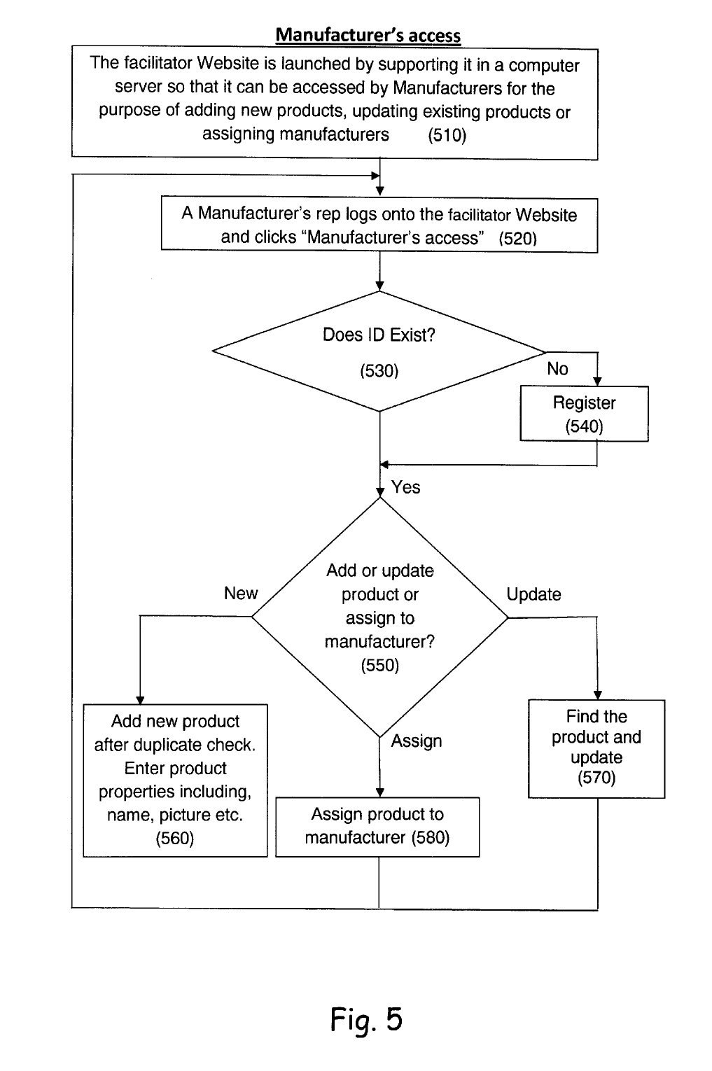

FIG. 5 is a detailed flow chart of a product distribution chain segment illustrating a manufacturer's access to the facilitator Website. The facilitator Website displays a separate list from which the distributors, in turn, make purchases from manufacturers or other distributors, performed according to the principles of the present invention. The facilitator Website is launched by supporting it in a computer server so that it can be accessed by Manufacturers for the purpose of adding new products, updating existing products or assigning manufacturers in reference block 510. A Manufacturer's rep logs onto the facilitator Website and clicks “Manufacturer's access” in reference block 520. If the manufacturer has not already registered in reference block 530, the rep does so in reference block 540.

After registering, or if the manufacturer is already registered, the rep is asked whether he wants to add or update one or more products or to assign one or more products to the manufacturer in reference block 550. New product(s) may be added after a check for duplication, including entering product properties, including name, picture, recommended price or no price, etc. in reference block 560. Alternatively, products may be updated in reference block 570. As another alternative products may be assigned to a manufacturer in reference block 580.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A method for setting up and operating a facilitator Website, the facilitator Website allowing each of a plurality of stores to create a corresponding proxy Web store presence, said method comprising:
launching the facilitator Website by supporting it in a computer server so that it can be accessed by consumers for the purpose of placing orders;
setting up a database for a template of products and services to be offered by each of said plurality of stores through said corresponding proxy Web store presence;
logging onto the facilitator Website by each of said plurality of stores;
clicking “New Web Store” on the homepage of the facilitator Website by each of said plurality of stores;
identifying and selecting items from said template of products and services to be offered by each of said plurality of stores that said plurality of stores carry, thereby immediately allowing each of said plurality of stores to create their own said corresponding proxy Web store presence,
placing an order by a consumer;
managing by the facilitator Website all of said orders that will be placed to the facilitator Website; and
communicating by the facilitator Website with the plurality of stores for handling said orders,
such that the facilitator Website is used for setting up said corresponding proxy Web store presence for each of said plurality of stores, through which consumers can contact one of said plurality of stores and make purchases.

2. The method of claim 1, further comprising providing of advertising space on the facilitator Website, thereby generating revenue for the facilitator Website,
such that said advertising can be targeted, in relation to use of the facilitator Website by consumers to place said orders, thereby developing a buying profile history, which is stored on said database, so as said consumer accesses the facilitator Website for another purchase, he is presented with advertising of a type related to said buying history.

3. The method of claim 1, wherein said plurality of stores are physical stores.

4. The method of claim 1, wherein at least one of said plurality of stores is a virtual store.

5. The method of claim 1, further comprising adding to the product list by manufacturers of products.

6. The method of claim 5, wherein said product list is added to manually.

7. The method of claim 5, wherein said product list is added to automatically.

8. The method of claim 1, wherein each of the products and services in said list may be accompanied by a display of at least: one photo; and identification.

9. The method of claim 8, wherein said display is multilingual.

10. The method of claim 1, wherein the proxy Web store Website is supporting it by a computer server accessible by said consumers.

11. The method of claim 1, wherein the proxy Web store Website is accessed through search engines.

12. The method of claim 11, wherein said search engine is a hardcopy yellow pages.

13. The method of claim 11, wherein said search engine is an electronic yellow pages.

14. The method of claim 1, wherein access is by direct contact if said consumer already knows the Web address of the facilitator Website, such that said consumer can enter it at his browser on the Internet and be directly linked to it.

15. The method of claim 1, further comprising identifying by one of said consumers of a store which he wishes to have associated with the facilitator Website, wherein said store is not yet listed on the facilitator Website, and said consumer may approach said store and suggest that said store be listed on the facilitator Website, and if the store agrees, contact can be made by the proxy Web store Website with said store.

16. The method of claim 15, wherein contact is made by one of said plurality of stores with said proxy Website concerning listing.

17. The method of claim 15, wherein said contact is made by at least one of: telephone; mobile phone; email; “snailmail;” and fax.

18. The method of claim 1, wherein the facilitator Website is accessed through a call center designated for this purpose, whereby the information to set up at least one of said plurality of stores is communicated, and said call center will work with the facilitator Website and create said corresponding Web store presence for each of said plurality of stores and be easy to maintain.

19. The method of claim 1, wherein the facilitator Website communicates with said at least one of said plurality of stores for placing orders.

20. The method of claim 19, wherein said communication is through the Internet if the store is equipped for this kind of order receiving approach.

21. The method of claim 19, wherein said communication is through fax.

22. The method of claim 19, wherein said communication is through SMS.

23. The method of claim 19, wherein said communication is through standard telephone.

24. The method of claim 19, wherein said communication is through cellular phone.

25. The method of claim 1, further comprising making available said product/services database that has been created on the Website for external use by other interested Websites as a product/services information resource.

26. The method of claim 1, further comprising at least one of:
charging for order handling on the facilitator Website;
paying a percentage of the purchase price by the Web store to the facilitator Website;
managing by the facilitator Website of all orders for such services as accounting, inventory and shipping;
arranging with one more delivery companies to defer part payment to the facilitator Website for shipping;
conducting by the facilitator Website of customer resource management (CRM) activities, including general business management, advertising campaigns, promotions and coupons; and
placing orders by e-order, fax, SMS, “snail-mail,” standard phone or mobile phone and charging a fee accordingly,
thereby generating revenue for the facilitator Website.

27. A system for setting up and operating a facilitator Website, the facilitator Website allowing each of a plurality of stores to create a corresponding proxy Web store presence, said system comprising:
means for launching the facilitator Website by supporting it in a computer server so that it can be accessed by consumers for the purpose of placing orders;
means for setting up a database for a template of products and services to be offered by each of said plurality of stores through said corresponding proxy Web store presence;
means for logging onto the facilitator Website by each of said plurality of stores;
means for clicking “New Web Store” on the homepage of the facilitator Website by each of said plurality of stores;
means for identifying and selecting items from said template of products and services to be offered by each of said plurality of stores that said plurality of stores carry, thereby immediately allowing each of said plurality of stores to create their own said corresponding proxy Web store presence,
means for placing an order by a consumer;
means for managing by the facilitator Website all of said orders that will be placed to the facilitator Website; and
means for communicating by the facilitator Website with the plurality of stores for handling said orders,
such that the facilitator Website is used for setting up said corresponding proxy Web store presence for each of said plurality of stores, through which consumers can contact one of said plurality of stores and make purchases.
